(19) United States
(12) Patent Application Publication
(10) Pub. No.: US 2009/0116622 A1
(43) Pub. Date: May 7, 2009

(54) DEVICE, SYSTEM AND METHOD OF TELECOMMUNICATIONS WIRE PAIR QUALIFICATION

(75) Inventors: Wayne A. Campbell, London (CA); Jonathan M. Cliffen, London (CA)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/934,365

(22) Filed: Nov. 2, 2007

(51) Int. Cl. H04M 1/24

(52) U.S. Cl. 379/1.03

(57) ABSTRACT

A portable testing device for testing a telecommunications line comprises a control circuit, a test module coupled to the control circuit, the test module including a DSLAM modem, and a relay matrix that includes a series of relays configured to connect with a plurality of wire pairs of the telecommunications line. A first wire pair is coupled to the control circuit via a transceiver and a second wire pair is coupled to the test module, where the relay matrix is coupled to the control circuit via a relay driver. The device, system and method of the present invention can be used to qualify the existing telecommunications line for broadband speed capacity and operation.

### BACKGROUND OF THE INVENTION

1. Field of the Invention

The present invention is directed to a device, system, and method for testing the quality of an existing telecommunications line to determine if that line is qualified to perform at a broadband speed and capacity.

2. Background

In the area of telecommunication networks, the drive for higher speed and higher capacity networks is paramount. As an example, telecommunications companies are often under pressure to deploy higher speed broadband services to their subscribers. These enhanced broadband services include high speed internet access, IPTV, and VOIP services.

Prior to launching a new service, the telephone company must ensure that the existing link to the subscribers, in a copper-wire context, typically a pair of telephone wires called a “twisted pair” or “wire pair,” are capable of carrying the planned broadband speeds. There are two conventional methods for assessing the broadband speed capacity of the wire pair prior to installation of the broadband equipment. The first conventional method involves simply making an estimate based on the length and configuration of the wire pair(s). A second conventional method includes measuring simple characteristics of the wire pair (e.g., resistance, capacitance, and induced noise) to infer or predict the capacity. However, these predictions and estimates are often not accurate.

Current test and measurement equipment includes devices that are referred to as Far End Devices (FEDs) that allow a technician to set up basic tests remotely between a telecommunications cabinet and a terminal. See e.g., Publication no. WO 99/34583. However, the types of testing are limited with conventional FEDs.

### SUMMARY

According to an exemplary aspect of the present invention, a portable testing device for testing a telecommunications line comprises a control circuit, a test module coupled to the control circuit, the test module including a DSLAM modem, and a relay matrix that includes a series of relays configured to connect with a plurality of wire pairs of the telecommunications line. A first wire pair is coupled to the control circuit via a transceiver and a second wire pair is coupled to the test module, where the relay matrix is coupled to the control circuit via a relay driver.

According to another aspect of the present invention, a system for testing a telecommunications line of a network that is disposed between a first network location and a second network location remote from the first network location comprises a first portable testing device coupled to the telecommunications line at the first network location, the first portable testing device including a control circuit, a test module coupled to the control circuit, the test module including a DSLAM modem, and a relay matrix that includes a series of relays configured to connect with a plurality of wire pairs of the telecommunications line. A first wire pair is coupled to the control circuit via a transceiver and a second wire pair is coupled to the test module, where the relay matrix is coupled to the control circuit via a relay driver. The system also includes a second portable testing device coupled to the telecommunications line at the second network location, the second portable testing device including a customer premise equipment (CPE) modem, where the second portable test device communicates commands with the first portable test device via the first wire pair. In one aspect, the first network location is a distribution cabinet and the second network location is a subscriber terminal.

According to another aspect of the present invention, a method for qualifying a telecommunications line of a network for xDSL service that is disposed between a first network location and a second network location remote from the first network location comprises providing a first portable testing device coupled to the telecommunications line at the first network location, the first portable testing device including a control circuit, a test module coupled to the control circuit, the test module including a DSLAM modem, and a relay matrix that includes a series of relays configured to connect with a plurality of wire pairs of the telecommunications line. A plurality of wire pairs of the telecommunications line are coupled to the first portable testing unit, where the plurality of wire pairs includes a first wire pair, a second wire pair, and a third wire pair. The first wire pair is coupled to the control circuit via a transceiver and one of the second wire pair and third wire pair is coupled to the test module, where the relay matrix is coupled to the control circuit via a relay driver. The method also includes providing a second portable testing device coupled to the telecommunications line at the second network location, the second portable testing device including a customer premise equipment (CPE) modem. The first wire pair and one of the second wire pair and third wire pair are coupled to the second portable testing device. A command signal is sent from the second portable testing device to the first portable testing device via the first wire pair. A data connection is established between the CPE modem of the second portable testing device and the DSLAM modem of the first portable testing device via one of the second wire pair and the third wire pair, the broadband speed being measurable at the second portable testing device.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIG. 1 is a schematic view of an existing telecommunications network and the testing system according to an exemplary aspect of the present invention.

FIG. 2 is a schematic block diagram of the components of the far end device of an exemplary aspect of the present invention.

FIG. 3 is a front view of a far end device of an exemplary aspect of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF THE EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., may be used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention is directed to a device, system, and method for testing the quality of an existing telecommunications line to determine if that line is qualified to perform at a high speed and capacity. The device, system and method can allow a telecommunications provider to make such a determination before the installation of expensive, permanent equipment at a particular network location, such as at a distribution cabinet. The device, system and method provide a way for a technician to qualify several communications lines, without requiring multiple technicians to perform the tests.

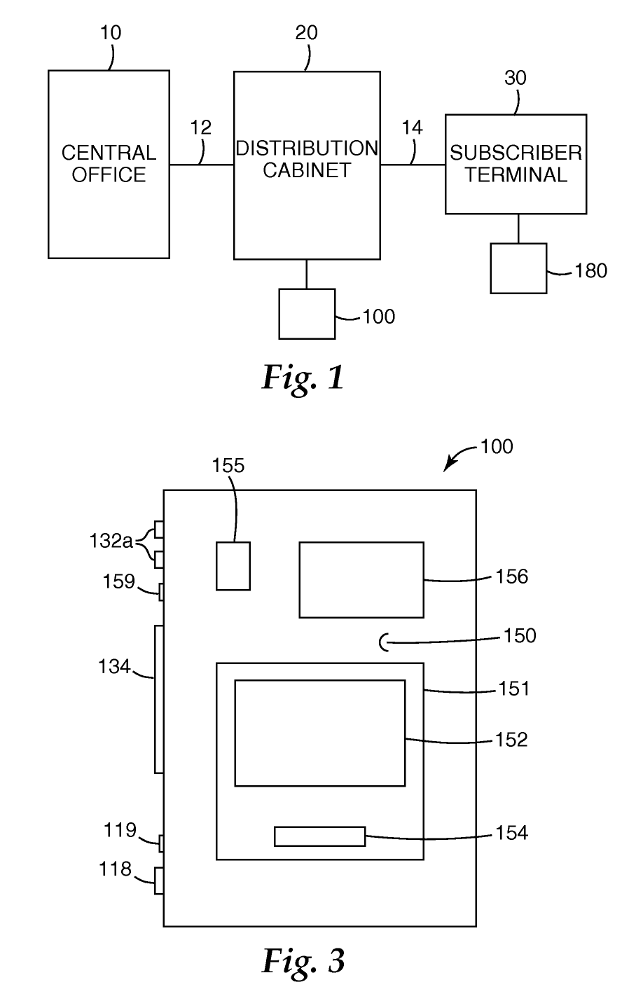

FIG. 1 shows a schematic view of a simplified communications network. A network provider's central office 10, an exchange of thousands or tens of thousands of switches, communicates with many different nodes of the network, including exemplary distribution cabinet 20. The distribution cabinet 20 may be located at a remote location, such as at a business complex, neighborhood or subdivision. As the existing network may still utilize copper wire pairs as a primary connection between an individual subscriber and the telecommunications network, the distribution cabinet 20 will include equipment, such as standard communications electronics and cross connects, to handle a few hundred or a few thousand copper wire pairs that are further distributed to subscriber terminals, such as terminal 30. Terminal 30 can be located at a distance of from about 100 yards to about 2 or 3 miles from cabinet 20. Terminal 30 then distributes at least some of the incoming wire pairs to individual subscribers of the network.

For example, in FIG. 1, communications cable 12 may include anywhere from a few hundred up to a few thousand telecommunications wire pairs emanating from the central office. From the distribution cabinet, communications cable 14 may include anywhere from a few to a few hundred telecommunications wire pairs. To determine whether these remote lines 14 are capable of high speed communications, a testing system can be utilized in accordance with exemplary embodiments of the present invention.

The testing system includes a Far End Device or FED 100 that is connected to a plurality of lines or wire pairs at a first network location and a diagnostic test unit that is connected to one or more of those same lines/wire pairs at a second network location. In the exemplary network of FIG. 1, the first network location is distribution cabinet 20 and the second network location is subscriber terminal 30. In alternative aspects, the first network location could be a network's central office or other access point in the network. In general, FED 100 will be operated remotely via commands generated at the diagnostic test unit 180. These commands can be standard DTMF signals or other standard network communications signals.

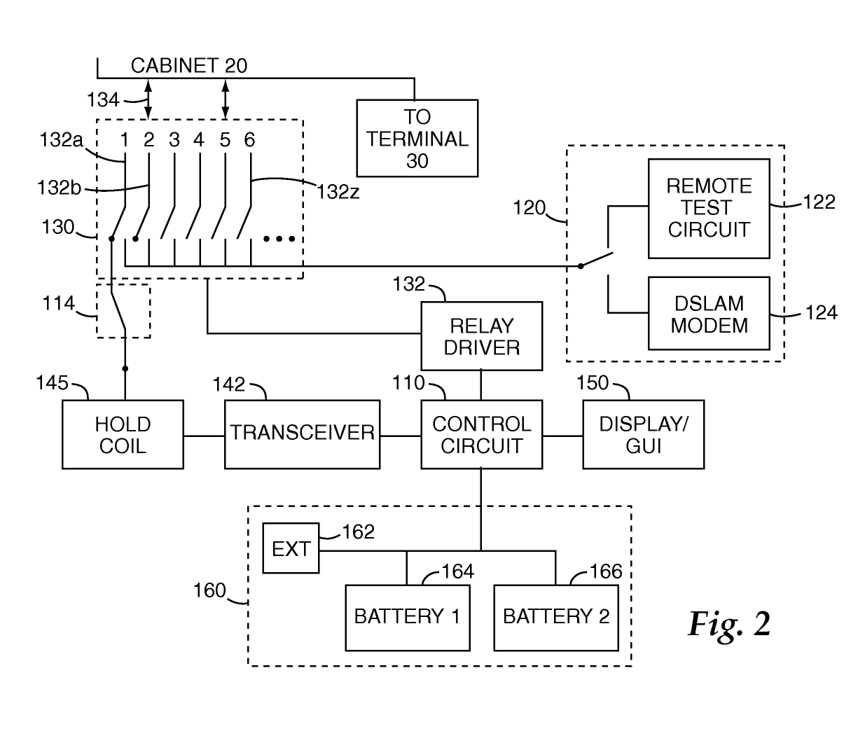

In an exemplary aspect, FED 100 is a “multi-pair” FED, meaning that it can be simultaneously connected with a plurality of wire pairs for communications and testing purposes. A block diagram of FED 100 is shown in FIG. 2. The main components of FED 100 include a control circuit 110, a test module 120, a relay matrix 130, and a transceiver 142. In addition, an optional display 150 and power source 160 can be utilized. These and other components will now be described in further detail.

The control circuit 110 is the central controller for the FED 100. Control circuit 110 can control display 150, one or more relay drivers 132, transceiver 142, and/or the test module 120. Control circuit 110 is primarily responsible for connecting the appropriate relays in relay matrix 130 and test module 120 in response to commands generated at the subscriber terminal. Additionally control circuit 110 controls power and operating modes for remote test circuit 122 and DSLAM modem 124. In one aspect, the control circuit 110 can comprise a microprocessor. The microprocessor can be a conventional microcontroller chip, such as an ATmega165P microcontroller available from Atmel Corporation (San Jose, Calif.). In an alternative aspect, control circuit 110 could be replaced by a dedicated electronic circuit or circuits. Additional controller chips or microprocessors can also be included in FED 100, such as for driving individual components. Power to control circuit 110 can be supplied by power source 160.

Control signals from the subscriber terminal are routed to the transceiver 142. In one aspect, the control signals comprise DTMF (“Dual Tone Multi-Frequency”) signals and the transceiver is a DTMF transceiver. In an exemplary embodiment, these command signals are routed over a control pair, predetermined by the operator to be either pair 1 or pair 2 (132a or 132b). Alternative embodiments could include routing the control signals over more than 2 pairs, or routing them over a separate pair dedicated for the control purpose. The DTMF transceiver 142 decodes the signals and passes them along to the control circuit 110.

As shown in FIG. 2, FED 100 further includes a test module 120 that allows the FED to operate in several different testing modes. Test module 120 provides standard diagnostic tests through its remote test circuit 122. The remote test circuit 122 can be utilized to apply basic test conditions (including shorts, tones, resistances, etc.) to the particular wire pair. The remote test circuit 122 can be configured as an available remote test circuit, such as the DYNATEL™ 1332 Far End Device, available from 3M Company (St. Paul, Minn.). In addition, test module 120 also provides a DSLAM (Digital Subscriber Line Access Multiplexer) modem 124 able to terminate an incoming high speed xDSL data connection from the subscriber terminal. The DSLAM modem 124 can comprise, for example, a conventional DSL circuit board, such as the Dr. DSL™ model 350 (or model 450) board, available from Aware, Inc. (Bedford, Mass.). In an exemplary aspect, control circuit 110 controls the connection of a test pair to either remote test circuit 122 or DSLAM modem 124.

In a first mode, remote test circuit 122 is able to respond to basic line quality tests initiated at the subscriber terminal site by the diagnostic test unit 180. In particular, the remote test circuit 122 responds to DTMF commands to enable loop resistance tests, resistive balance tests, single tone tests, sweep loss tests, and longitudinal balance tests (e.g., with standard IEEE termination).

In a second mode, DSLAM modem 124 is able to establish a broadband connection initiated at the subscriber terminal by the diagnostic test unit 180. In particular, the DSLAM modem can be configured to emulate a variety of xDSL technologies (ADSL, ADSL2, ADSL2+, VDSL, VDSL2, HDSL, HDSL2, and others). Once connected, the diagnostic test unit 180 can display the broadband speed achieved for the wire pair under test. Thus, line qualification between a subscriber terminal site and a distribution cabinet can be conducted without having to first install a permanent DSLAM at the distribution cabinet.

As shown in FIG. 2, FED 100 further includes a relay matrix 130. The relay matrix 130 provides the interface between the FED 100 and the wire pairs of the network. At the other end of the wire pairs, the diagnostic test unit 180 can perform qualification tests. The relay matrix comprises a plurality of switches/relays 132a-132z (in this example, relays 1-6 are shown) which correspond to the number of wire pairs that can be tested by the system at any one time. Relay driver 132 can be utilized to activate the particular relay that corresponds to the wire pair being tested.

In preferred aspects, relay matrix 130 can include at least 5, 10, 15, 20 or 25 relays, so that multiple wire pairs can be set up for high speed qualification testing. For example, in one aspect, the FED 100 can be connected to at least 10 wire pairs. In another aspect, the FED 100 can be connected to at least 25 wire pairs.

In addition, one of the relays, for example either relay 132a or relay 132b, can be established as a control pair to communicate control signals to and from the control circuit 110. In this exemplary aspect, line pair 1 or line pair 2 can be selected as the control pair by the technician. A switch 114 coupled to the control circuit can be utilized to switch to either line pair 1 or line pair 2. The DTMF transceiver 142 is configured to send and detect the control signals that are carried on the control pair. A hold coil 145 can optionally be included to create the loop current to enable these control signals to originate in an unpowered handset at the subscriber terminal.

In an alternative aspect, the FED 100 can automatically select one of the multiple wire pairs as the control pair. In this alternative aspect, the FED 100 (e.g., control circuit 110) can scan the wire pairs coupled to the relay matrix 130 to look for command signals generated by the diagnostic test unit 180.

As shown in FIG. 2, FED 100 also includes a power source 160 for powering the FED 100 and the control circuit 110. In an exemplary aspect, power to FED 100 is supplied by batteries. As is schematically represented, more than one battery source can be utilized. For example, a first battery source 164 can comprise standard alkaline batteries disposed internally in FED 100. Also, a second battery source 166, separate from the FED 100 unit, can be provided, such as a rechargeable, auxiliary battery pack, e.g., a lead acid battery pack, to supply additional DC power to FED 100, especially during high speed testing and other testing modes that require more power. A charger 162 can be provided to recharge the auxiliary battery back using a standard wall plug. In another aspect, the unit can automatically turn off to conserve power when command signals have not been received by the unit for a selected period of time. Alternatively, FED 100 can be configured to run on standard AC power from a wall source, as would be apparent to one of ordinary skill in the art given the present description.

FED 100 can also include a display 150, which can further include a keyboard or GUI (Graphical User Interface), that allows the technician to view set-up and operation, and it also provides an interface for the technician to perform some operations. While the FED 100 will generally be operated remotely via DTMF commands from the diagnostic test unit 180, the display 150 can be made available to help the technician set up the unit and to help with understanding the operation of the unit for training and troubleshooting purposes.

In more detail, as is shown in FIG. 3, display/GUI 150 can include a main display area 151 that includes a first section 152 that provides a visual indication of the wire pair being tested. In an exemplary aspect, display area 152 includes an array of LEDs (Light Emitting Diodes), each corresponding to a different wire pair number. When a particular LED is lit, this indicates that particular wire pair is under test. Display area 151 can also include a second section 154 that indicates the type of testing mode being utilized (e.g., either basic diagnostic mode or high speed/xDSL mode). The display 150 can also optionally include a third section 156 that indicates which power source is being utilized and the power level of that power source.

A power on/power off switch 155 can also be provided in the display area.

Alternatively, display 150 can comprise a touch-based LCD (Liquid Crystal Display) that provides a technician the ability to operate the FED 100 with touch-based commands and simultaneously view activity from a single display.

FED 100 also includes several different connection ports. In the example of FIG. 3, these connection ports are provided on a side of the FED 100 unit for convenience, but they may alternatively be placed on the rear, bottom, top, or front portion of the FED 100 unit, as would be apparent to one of ordinary skill in the art given the present description. For example, a first port 134 can receive a multi-pair connector or bus. In an exemplary aspect, a 25 wire pair connector can be used in conjunction with a standard key cable that connects the FED 100 to the wire pairs under test. Additionally, FED 100 can include a separate connection port(s) 132a for the control pair (Tip and Ring). DTMF commands can be sent from the diagnostic test unit 180 to select a particular test pair and to set the particular operating mode of the FED 100. FED 100 can also include a ground plug 119 which is required for some diagnostic tests. Also, an auxiliary power port 118 can be included to connect the FED 100 to an auxiliary battery pack or external power source, as appropriate.

FED 100 can also include an additional indicator light 159, here mounted on the side of the FED 100 unit, to indicate a power on/power off state. This type of indicator is useful when the FED 100 unit is placed on edge in a cabinet, where the front face of the unit is not easily visible.

Referring back to FIG. 1, the qualification system further includes a diagnostic test unit 180. The diagnostic test unit 180 is preferably configured as a portable, subscriber loop analyzer, such as a DYNATEL™ 965 AMS unit, available from 3M Company (St. Paul, Minn.). Other conventional analyzers from other loop analyzer vendors can also be utilized with the FED 100 of the present invention.

The diagnostic test unit 180 includes a customer premise equipment (CPE) modem, a power supply, a display, and appropriate connectors and ports for interfacing to the network. In addition, the diagnostic test unit 180 can comprise one or more particular test sets, provided as individual modules or as a microprocessor-controlled, integrated test set. In an exemplary aspect, the diagnostic test unit 180 can perform multiple basic diagnostic tests, such as fault location, repair verification, TDR based-testing, and other tests, including full-featured POTS testing, spectrum analyzer tests, noise determination, ISDN testing and full media testing. In addition, devices such as the DYNATEL™ 965 AMS unit can include DSL-based modules that perform xDSL rate (e.g., ADSL2+, VDSL2, etc.) connection tests. Overall, the diagnostic test unit 180, independently or with additional modules, can be programmed to perform any number of tests as appropriate. The xDSL-rate tests can be performed along a selected line pair coupled to the diagnostic test unit 180 and the FED 100. The diagnostic test unit 180 can also send DTMF (or other) command signals along the control pair to communicate with the FED 100 to initiate particular test modes or select a particular wire pair to be tested.

In operation, the test system (FED 100 and diagnostic test unit 180) can be utilized in the following manner. A technician can enter a first network location, such as a distribution cabinet 20, a cross connect cabinet or other access point, in order to test particular wire pairs of the network. This location can be referred to as the “far end” for testing purposes. The technician can connect a first (Tip and Ring) wire pair as the control pair for the FED 100 unit (for example, in port 132a). Additional wire pairs of the network can then be connected to the FED 100 using, e.g., a standard telecommunications key cable and connector, where a first end of the cable is coupled to multi-pair connector port 134 via a multi-pair connector and the other end of the cable can be stripped down and/or connected to the pairs under test at the cross connect cabinet. The appropriate power supply is connected and the unit is turned on.

After connection and powering at the distribution cabinet 20, the technician can leave the FED 100 at the distribution cabinet 20 and travel to a second network location, such as a particular subscriber terminal 30. First, the control pair wires can be identified at the subscriber terminal and connected to the diagnostic test unit 180. This establishes command communication with the FED 100 and thus command signals can be sent to the FED 100.

For example, a DTMF command can be sent to connect one of the wire pairs (e.g., the second wire pair, a third wire pair, a fourth wire pair, etc.) to the DSLAM modem 124 via the relay matrix 130. Test leads or other connectors of the test unit 180 can be utilized to measure a test signal communicated along a particular wire pair (e.g., the second wire pair, the third wire pair, etc.) at the subscriber terminal to test the quality of the line, under, e.g., basic or DSL-type testing.

A data connection can be established between the CPE modem of the diagnostic test unit 180 and the DSLAM modem of the FED 100 via one of the selected wire pairs. In this manner, the broadband speed is directly measurable by the diagnostic test unit 180. For example, a VDSL service can provided on the second wire pair and the quality of the signal can be directly measured by the diagnostic test unit 180. Other wire pairs at the subscriber terminal 30 can then be checked in any particular sequence. Test initiation and completion can be indicated audibly or visually by the display of the diagnostic test unit 180. In addition, power levels and other features of the FED 100 can be checked remotely by the diagnostic test unit 180. The FED 100 and diagnostic unit 180 can be used to check DSL service rates and then, should the rates be too low, the remote test circuit 122 features in conjunction with diagnostic unit 180 can be employed to determine cause of the poor service rates.

After completion of the first set of tests at the first terminal, the technician can travel to another subscriber terminal to perform further testing, or back to the distribution cabinet 20, repeat the hook up for another set of wire pairs, then travel to the next subscriber terminal for further testing.

Thus, the device, system and method of the present invention can be used to determine xDSL service capacity, including directly determining the broadband speed capacity, as opposed to having to use an estimate. With the FED 100 described herein, a telecommunications provider can temporarily incorporate a portable DSLAM modem at any network location, including distribution cabinet 20, and quickly qualify or troubleshoot an existing line for xDSL service. In addition, the FED 100 configuration provides a device that connects a DSLAM modem to multiple wire pairs to simplify the testing process.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

What is claimed is:

1. A portable testing device for testing a telecommunications line, comprising:
a control circuit;
a test module coupled to the control circuit, the test module including a DSLAM modem; and
a relay matrix that includes a series of relays configured to connect with a plurality of wire pairs of the telecommunications line, wherein a first wire pair is coupled to the control circuit via a transceiver and a second wire pair is coupled to the test module, wherein the relay matrix is coupled to the control circuit via a relay driver.

2. The portable testing device of claim 1, further comprising:
a power source coupled to the control circuit and test module, and
a display coupled to the control circuit.

3. The portable testing device of claim 2, wherein the display indicates a power level of the power source and the identity of the wire pair coupled to the test module via the relay matrix.

4. The portable testing device of claim 1, wherein the relay matrix that includes a series of relays configured to connect with at least 10 wire pairs of the telecommunications line.

5. The portable testing device of claim 1, wherein the relay matrix that includes a series of relays configured to connect with at least 25 wire pairs of the telecommunications line.

6. The portable testing device of claim 1, wherein the test module further includes a remote test circuit, wherein the relay matrix is coupled to one of the remote test circuit and the DSLAM modem.

7. A system for testing a telecommunications line disposed in a network between a first network location and a second network location remote from the first network location, comprising:
a first portable testing device coupled to the telecommunications line at the first network location, the first portable testing device including a control circuit, a test module coupled to the control circuit, the test module including a DSLAM modem, and a relay matrix that includes a series of relays configured to connect with a plurality of wire pairs of the telecommunications line, wherein a first wire pair is coupled to the control circuit via a transceiver and a second wire pair is coupled to the test module, wherein the relay matrix is coupled to the control circuit via a relay driver; and
a second portable testing device coupled to the telecommunications line at the second network location, the second portable testing device including a customer premise equipment (CPE) modem, wherein the second portable test device communicates commands with the first portable test device via the first wire pair.

8. The system of claim 7, wherein the first network location comprises a distribution cabinet and the second network location comprises a subscriber terminal.

9. The system of claim 7, wherein a command signal sent from the second portable testing device to the first portable testing device triggers the first portable testing device to disconnect the test module from the second wire pair and to connect the test module to a third wire pair.

10. The system of claim 7, wherein a command signal sent from the second portable testing unit to the first portable testing device triggers the first portable testing device to connect the second wire pair to the DSLAM modem.

11. The system of claim 7, wherein the second portable testing device includes one or more test sets, wherein a command signal sent from the second portable testing device to the first portable testing device triggers the first portable testing device to connect the second wire pair to a remote test circuit disposed in the test module.

12. The system of claim 7, wherein the first portable test device includes a display that indicates a power level of the power source and the identity of the wire pair coupled to the test module via the relay matrix.

13. The system of claim 7, wherein the relay matrix includes a series of relays configured to connect with at least 25 wire pairs of the telecommunications line.

14. The system of claim 7, wherein the first portable testing device further comprises a remote test circuit, wherein the relay matrix is coupled to one of the remote test circuit and the DSLAM modem.

15. A method for qualifying a telecommunications line for xDSL service of a network disposed between first network location and a second network location, comprising:
providing a first portable testing device coupled to the telecommunications line at the first network location, the first portable testing device including a control circuit, a test module coupled to the control circuit, the test module including a DSLAM modem, and a relay matrix that includes a series of relays configured to connect with a plurality of wire pairs of the telecommunications line;
coupling a plurality of wire pairs of the telecommunications line to the first portable testing unit, wherein the plurality of wire pairs includes a first wire pair, a second wire pair, and a third wire pair, wherein the first wire pair is coupled to the control circuit via a transceiver and one of the second wire pair and third wire pair is coupled to the test module, wherein the relay matrix is coupled to the control circuit via a relay driver;
providing a second portable testing device coupled to the telecommunications line at the second network location, the second portable testing device including a customer premises equipment (CPE) modem;
coupling the first wire pair and at least one of the second wire pair and third wire pair to the second portable testing device;
sending a command signal from the second portable testing device to the first portable testing device via the first wire pair; and
establishing a data connection between the CPE modem of the second portable testing device and the DSLAM modem of the first portable testing device via one of the second wire pair and the third wire pair, the broadband speed measurable at the second portable testing device.

16. The method of claim 15, wherein the command signal is a DTMF command that signals the first portable testing device to disconnect the second wire pair from the DSLAM modem via the relay matrix and to connect the third wire pair to the DSLAM modem via the relay matrix.

17. The method of claim 15, further comprising sending a second command signal to the first portable testing device, wherein the second command signal is a DTMF command that signals the first portable testing device to connect the second wire pair to one of the DSLAM modem and a remote test circuit disposed in the test module.

18. The method of claim 15, wherein the first network location comprises a distribution cabinet and the second network location comprises a subscriber terminal.
